(19) United States
(12) Patent Application Publication
(10) Pub. No.: US 2026/0367448 A1
(43) Pub. Date: Nov. 19, 2026

(54) OPTICAL CONSTRUCTION AND OPTICAL SYSTEM

(71) Applicant: 3M INNOVATIVE PROPERTIES COMPANY, St. Paul, MN (US)

(72) Inventors: Adam D. Haag, Woodbury, MN (US); Lin Zhao, Woodbury, MN (US); Gilles J. Benoit, Minneapolis, MN (US); Hideaki Shirotori, Kanagawa (JP)

(21) Appl. No.: 19/180,456

(22) PCT Filed: Oct. 13, 2023
(86) PCT No.: PCT/IB2023/060362

§ 371 Date: Apr. 16, 2025

Related U.S. Application Data
(60) Provisional application No. 63/381,335, filed on Oct. 28, 2022.

(51) Int. Cl. G02F 1/13357; G02F 1/1335

(52) U.S. Cl. CPC G02F 1/13362; G02F 1/133603; G02F 1/133614; G02F 1/133624

(57) ABSTRACT

An optical construction includes reflective and absorbing polarizers. An optical system includes an illumination source and the optical construction disposed on an emission surface thereof. A blue emission spectrum of light emitted by the illumination source has a blue maximum and a corresponding FWHM extending from a first blue wavelength to a second blue wavelength. For a partial blue wavelength range extending from a third blue wavelength at a five-percentage of the blue maximum to the first blue wavelength, and a green-red wavelength range extending from about 490 to 670 nm, for a block polarization state, the reflective polarizer has an average transmission of greater than about 40% in the partial blue wavelength range and an average transmission of less than about 30% in the green-red wavelength range, and the absorbing polarizer has an average absorption of greater than about 50% for each wavelength in the partial blue wavelength range.

### TECHNICAL FIELD

The present description relates generally to optical constructions and optical systems useful in displays.

### BACKGROUND

A liquid crystal display can include an absorbing polarizer and a reflective polarizer disposed between a display panel and an illumination source.

### SUMMARY

In some aspects, the present description provides an optical construction including a reflective polarizer and an absorbing polarizer. The reflective polarizer is partially transmissive in the block state for low wavelength blue light and absorbing polarizer substantially absorbs the low wavelength blue light in the block state transmitted by the reflective polarizer. The optical construction can be useful in backlit display systems, for example, to reduce recycling, and therefore brightness, of low wavelength blue light. In some aspects, the present description provides an optical system including the optical construction.

In some aspects, the present description provides an optical system including an extended illumination source configured to emit light from an extended emission surface thereof toward a display panel for forming an image, where the emitted light comprises a blue emission spectrum having a blue maximum at a blue maximum wavelength and a corresponding blue full width at half the blue maximum (FWHM) extending from a smaller first blue wavelength to a longer second blue wavelength; a reflective polarizer disposed on the emission surface of the extended illumination source and including a plurality of polymeric layers numbering at least 10 in total, where each of the polymeric layers can have an average thickness of less than about 500 nm; and an absorbing polarizer disposed on the reflective polarizer opposite the extended emission surface, such that for a substantially normally incident light, a visible wavelength range extending from about 420 nm to about 680 nm, a first partial blue wavelength range extending in increasing wavelengths from a third blue wavelength at a five-percentage of the blue maximum to the first blue wavelength, and a green-red wavelength range extending from about 490 nm to about 670 nm: for a first polarization state, each of the reflective polarizer and the absorbing polarizer has an average optical transmission of greater than about 60% in the visible wavelength range, and an optical transmission of greater than about 50% for each wavelength in the first partial blue wavelength range; and for an orthogonal second polarization state, the reflective polarizer has an average optical transmission of greater than about 40% in the first partial blue wavelength range and an average optical transmission of less than about 30% in the green-red wavelength range, and the absorbing polarizer has an average optical absorption of greater than about 60% in the visible wavelength range, and an optical absorption of greater than about 50% for each wavelength in the first partial blue wavelength range.

In some aspects, the present description provides an optical construction including a reflective polarizer including a plurality of polymeric layers that can number at least 100 in total, where each of the polymeric layers can have an average thickness of less than about 500 nm; and an absorbing polarizer disposed on, and substantially coextensive in length and width with, the reflective polarizer, such that for a substantially normally incident light, a blue wavelength range extending from about 420 nm to about 480 nm, and a green-red wavelength range extending from about 490 nm to about 670 nm: for an in-plane first polarization state, each of the reflective polarizer and the absorbing polarizer has an average optical transmission of greater than about 60% for each of the blue and the green-red wavelength ranges; and for an in-plane orthogonal second polarization state, the reflective polarizer has an average optical transmission of between about 40% and about 95% in the blue wavelength range and an average optical transmission of less than about 30% in the green-red wavelength range, and the absorbing polarizer has an average optical absorption of greater than about 60% in each of the blue and green-red wavelength ranges.

In some aspects, the present description provides an optical system including an illumination source configured to emit light for illuminating a display panel to form an image, where the emitted light comprises a blue emission spectrum having a blue maximum at a blue maximum wavelength and a lower blue wavelength at a five-percentage of the blue maximum and smaller than the blue maximum wavelength; a reflective polarizer disposed on the illumination source; and an absorbing polarizer disposed on the reflective polarizer opposite the illumination source, such that for a substantially normally incident light: for a first polarization state, each of the reflective polarizer and the absorbing polarizer has an average optical transmission of greater than about 60% a visible wavelength range extending from about 420 nm to about 680 nm; and for an orthogonal second polarization state, an optical transmittance of the reflective polarizer versus wavelength comprises a left band edge along which, with increasing wavelengths, the optical transmittance of the reflective polarizer decreases from about 90% to about 10%, the left band edge intersecting the blue emission spectrum at a higher blue wavelength disposed between the lower blue wavelength and the blue maximum wavelength. In a first partial blue wavelength range from the lower blue wavelength to the higher blue wavelength and a second partial blue wavelength range from the higher blue wavelength to about 480 nm, the reflective polarizer has respective average optical transmittances Tav1 and Tav2, Tav1/Tav2≥2, and the absorbing polarizer can have an average optical absorption of greater than about 50% in each of the first and second partial blue wavelength ranges.

These and other aspects will be apparent from the following detailed description. In no event, however, should this brief summary be construed to limit the claimable subject matter.

### BRIEF DESCRIPTION OF THE DRAWINGS

FIG. 1 is a schematic exploded cross-sectional view of an optical system including an optical construction, according to some embodiments.

FIG. 2 is a schematic cross-sectional view of a reflective polarizer, according to some embodiments.

FIG. 3 is a plot of layer thickness versus layer number for an illustrative reflective polarizer.

FIG. 4 is a schematic cross-sectional view of an absorbing polarizer, according to some embodiments.

FIG. 5 is a plot of normal incidence transmittance for various illustrative reflective polarizers and a light source emission intensity versus wavelength, according to some embodiments.

FIG. 6 is a plot of normal incidence transmittance for five of the illustrative reflective polarizers and the light source emission intensity of FIG. 5 versus wavelength, according to some embodiments.

FIGS. 7A-7B are plots of normal incidence transmittance for two of the illustrative reflective polarizers and the light source emission intensity of FIG. 5 versus wavelength, according to some embodiments.

FIGS. 8A-8B are schematic plots of the normal incidence transmittance, absorption, or reflectance for various optical elements for various polarization states, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

A display system can include a reflective polarizer disposed between an absorbing polarizer and an extended illumination source (e.g., a backlight). The reflective polarizer can be included to increase brightness by recycling light that would otherwise be absorbed by the absorbing polarizer. In some cases, it may be desired to reduce low wavelength (e.g., less than about 450 nm) blue light emitted by the display since such light has been said to have harmful effects to the human eye under extended exposure. It has been found, according to some embodiments of the present description, that a reduction in such low wavelength emitted light can be achieved by shifting a left reflection band edge of the reflective polarizer for a block polarization state into the blue wavelength range to reduce the recycling of low wavelength blue light and thereby reduce the increase in brightness due to recycling for those wavelengths. The absorbing polarizer can be configured to absorb the low wavelength blue light in the block polarization state that is transmitted through the reflective polarizer.

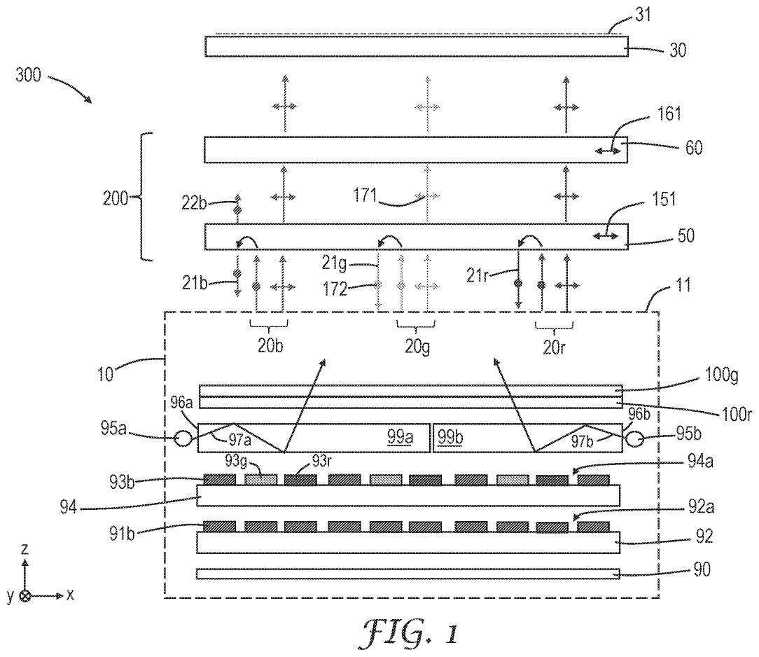

FIG. 1 is a schematic exploded cross-sectional view of an optical system 300 including an optical construction 200, according to some embodiments. The optical construction 200 includes an absorbing polarizer 60 and a reflective polarizer 50. Pass axes 151 and 161 of the respective reflective and absorbing polarizers 50 and 60 are schematically indicated. The reflective and absorbing polarizers can substantially transmit substantially normally incident (e.g., within about 30, 20, 10, or 5 degrees of normally incident) light having a first polarization state (e.g., polarized along the x-axis referring to the illustrated x-y-z coordinate system or polarization state 171) in a visible wavelength range (e.g., extending from about 420 nm to about 680 nm) and substantially block (e.g., reflect or absorb) light having an orthogonal second polarization state (e.g., polarized along the y-axis or polarization state 172) in at least a portion of the visible wavelength range. The first and second polarization states may be referred to as pass and block polarization states, respectively. The reflective polarizer 50 and the absorbing polarizer 60 are schematically shown as substantially transmitting pass state light while reflective polarizer 50 is schematically shown as substantially reflecting block state light for green and red lights 20g and 20r, and reflecting a portion 21b of blue light 20b having the block polarization state while transmitting a portion 22b of blue light 20b having the block polarization state which is substantially absorbed by the absorbing polarizer 60.

The optical system 300 can include an extended illumination source 10 configured to emit light (20b, 20g, 20r) from an extended emission surface 11 thereof toward a display panel 30 for forming an image 31. The optical system 300 may refer to the optical system defined by the optical construction 200 and the extended illumination source 10, or the optical system 300 can further include a display panel 30 disposed on the absorbing polarizer 60 opposite the reflective polarizer 50 and configured to receive the emitted light from the extended illumination source 10 and form an image 31. In some embodiments, the extended illumination source 10 includes a back reflector 90 configured to recycle at least some of the emitted light reflected (21b, 21g, 21r) toward the extended illumination source 10 by at least the reflective polarizer 50. In some embodiments, the back reflector 90 has an average optical reflectance of at least 60%, or 70%, or 80%, or 90%, or 95% in the visible wavelength range for at least the second polarization state 172. Suitable back reflectors include, for example, 3M Enhanced Specular Reflector (ESR) film available from 3M Company, St. Paul, MN. The extended illumination source 10 can include any one or more of illumination sources commonly used in backlights of liquid crystal display panels, for example. Suitable illumination sources include edge lit lightguide(s), arrays of (e.g., red, green and blue) light emitting diodes (LEDs), and light converting films (e.g., phosphor or quantum dot based films) disposed on an array of blue LEDs, for example. As described further elsewhere herein, various features of the transmission spectrum of the reflective polarizer 50 may be related to a blue emission spectrum of the illumination sources.

The reflective polarizer 50 can be a multilayer optical film reflective polarizer. As is known in the art, multilayer optical films including alternating polymeric layers can be used to provide desired reflection and transmission in desired wavelength ranges and desired polarization states by suitable selection of layer thicknesses and refractive index differences. Multilayer optical films and methods of making multilayer optical films are described in U.S. Pat. No. 5,882,774 (Jonza et al.); U.S. Pat. No. 6,783,349 (Neavin et al.); U.S. Pat. No. 6,949,212 (Merrill et al.); U.S. Pat. No. 6,967,778 (Wheatley et al.); and U.S. Pat. No. 9,162,406 (Neavin et al.), for example.

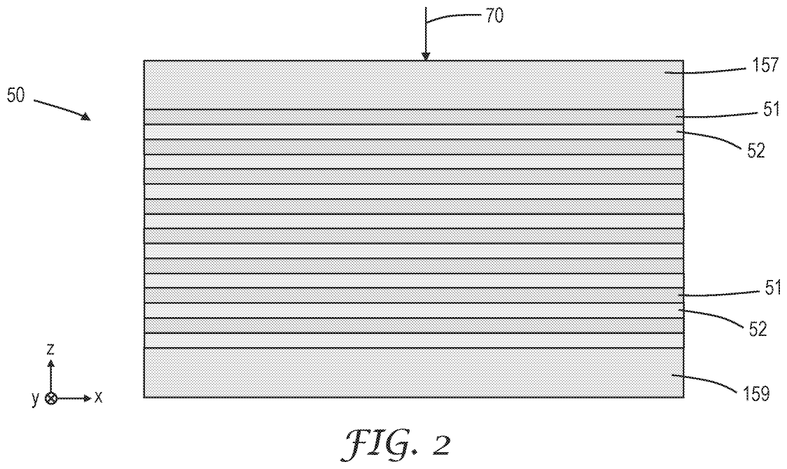

FIG. 2 is a schematic cross-sectional view of a reflective polarizer 50, according to some embodiments. The reflective polarizer 50 includes a plurality of layers 51, 52 that can number at least 10, or 25, or 50, or 100, or 150, or 200, or 250, or 300, or 350, or 400, or 450, or 500, or 550, or 600 in total. The plurality of layers 51, 52 can number up to 2000, or 1500, or 1200, or 1000, for example.

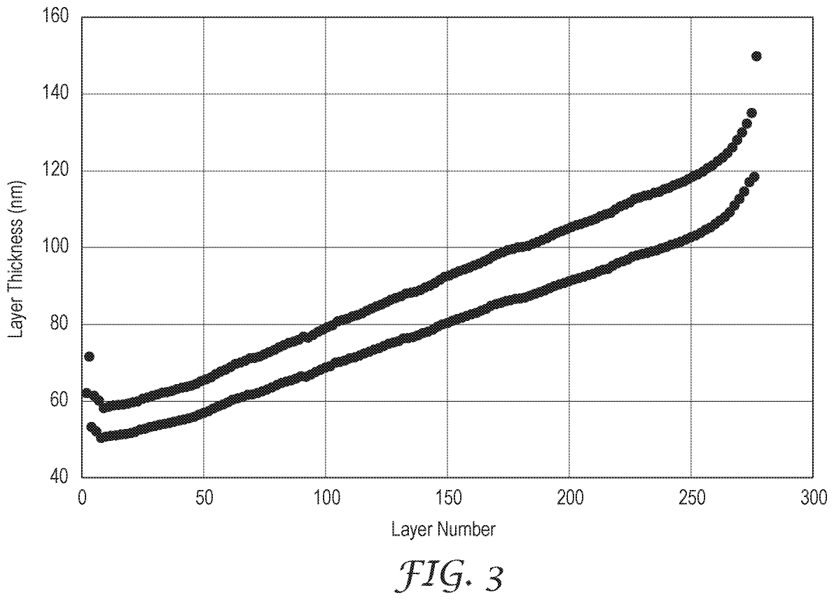

FIG. 3 is a plot of layer thickness versus layer number (which may be referred to as a layer thickness profile) for an illustrative reflective polarizer. In some embodiments, each of the polymeric layers 51, 52 have an average thickness of less than about 500, or 400, or 300, or 200 nm. Each of the polymeric layers 51, 52 can have an average thickness of greater than about 25 or 40 nm, for example. For the reflective polarizer of FIG. 3, each of the polymeric layers 51, 52 has a thickness in a range of about 50 nm to about 150 nm.

The polymeric layers 51, 52 can be disposed between skin layers 157, 159. The skin layers 157, 159 can have average thickness of greater than about 500 nm, or 1 micron, or 2 microns, or 4 microns, for example. The average thickness of the skin layers can be up to about 25 or 15 microns, for example.

In some embodiments, an optical construction 200 (see, e.g., FIG. 1) includes a reflective polarizer 50 including a plurality of polymeric layers 51, 52 (see, e.g., FIG. 2) numbering at least 100 (or in a range described elsewhere herein) in total where each of the polymeric layers has an average thickness of less than about 500 nm (or in a range described elsewhere herein); and an absorbing polarizer 60 disposed on, and substantially coextensive in length (e.g., along x-axis) and width (e.g., along y-axis) with, the reflective polarizer 50.

Layers or elements can be described as substantially coextensive with each other in length and width if at least about 60% of the length and width of each layer or element is co-extensive with at least about 60% of the length and width of each other layer or element. In some embodiments, for layers or elements described as substantially coextensive with each other in length and width, at least about 70% or at least about 80% or at least about 90% of each layer or element is coextensive in length and width with at least about 70% or at least about 80% or at least about 90% of the length and width of each other layer or element.

In some embodiments, the plurality of polymeric layers 51, 52 in the reflective polarizer includes a plurality of alternating different polymeric first (51) and second (52) layers numbering at least 10, or 25, or 50, or 100, or 150, or 200, or 250, or 300, or 350, or 400, or 450, or 500, or 550, or 600 in total. Each of the polymeric first and second layers can have an average thickness of less than about 500 nm or in another range described for the plurality of polymeric layers. For example, in some embodiments, the plurality of polymeric layers in the reflective polarizer includes a plurality of alternating different polymeric first and second layers numbering at least 150 in total where each of the polymeric first and second layers has an average thickness of less than about 400 nm. The polymeric first layers 51 can have a higher refractive index than the polymeric second layers 52 for the block polarization state. In some embodiments, the polymeric first layers may include, for example, polyethylene naphthalate (PEN), copolymers containing PEN and polyesters (e.g., polyethylene terephthalate (PET) or dibenzoic acid), glycol modified polyethylene terephthalate and the polymeric second layers may include, for example, copolyesters based on PEN, copolyesters based on PET, polycarbonate (PC), or blends of any two or three of these classes of materials. Other suitable polymeric materials for the first and second layers are described in the multilayer optical film references mentioned elsewhere herein.

In some embodiments, the polymeric first and second layers have respective indices nx1 and nx2 along an in-plane first direction (e.g., x-direction), respective indices ny1 and ny2 along an in-plane second direction (e.g., y-direction), and respective indices nz1 and nz2 along a thickness direction (e.g., z-direction) orthogonal to the first and second directions. In some embodiments, the first polymeric layers 51 are PEN layers and the second polymeric layers comprise at least one of a polycarbonate or a copolyester (e.g., copolyester based on PEN and/or copolyester based on PET). The second polymeric layers can be a blend of polycarbonate and copolyester(s), for example. In some such embodiments, for a wavelength of about 550 nm, the refractive indices along the first, second and third directions for the first polymeric layers 51 are about 1.84, 1.60 and 1.56, respectively, and the refractive indices along the first, second and third directions for the second polymeric layers are about 1.58, 1.58 and 1.58, respectively. In some embodiments, for at least one visible wavelength (e.g., 550 nm) in the visible wavelength range, nx1 is greater than nx2 by at least 0.05, or 0.1, or 0.15, or 0.2. The difference in nx1 and nx2 can be up to 0.8, 0.6, or 0.5, for example. In some embodiments, for the at least one visible wavelength, a magnitude of a difference between ny1 and ny2 is less than about 0.04, or 0.03, or 0.02, or 0.01. In some embodiments, for the at least one visible wavelength, a magnitude of a difference between nz1 and nz2 is less than about 0.04, or 0.035, or 0.03, or 0.025.

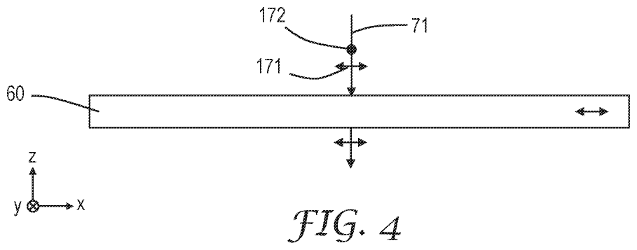

FIG. 4 is a schematic cross-sectional view of an absorbing polarizer 60, according to some embodiments. In some embodiments, for substantially normally incident light 71 and a visible wavelength range (e.g., about 420 nm to about 680 nm), the absorbing polarizer 60 substantially transmits (e.g., average optical transmission greater than about 60%) a first polarization state 171 and substantially absorbs (e.g., average optical absorption greater than about 60%) a second polarization state 172. Suitable absorbing polarizers include iodine stained polyvinyl alcohol (PVA) based polarizers and polarizers incorporating dichroic dyes in an oriented polymer layer, for example. Useful absorbing polarizers are commercially available and include the SR5519 polarizer available from San Ritz Corp. (Tokyo, Japan).

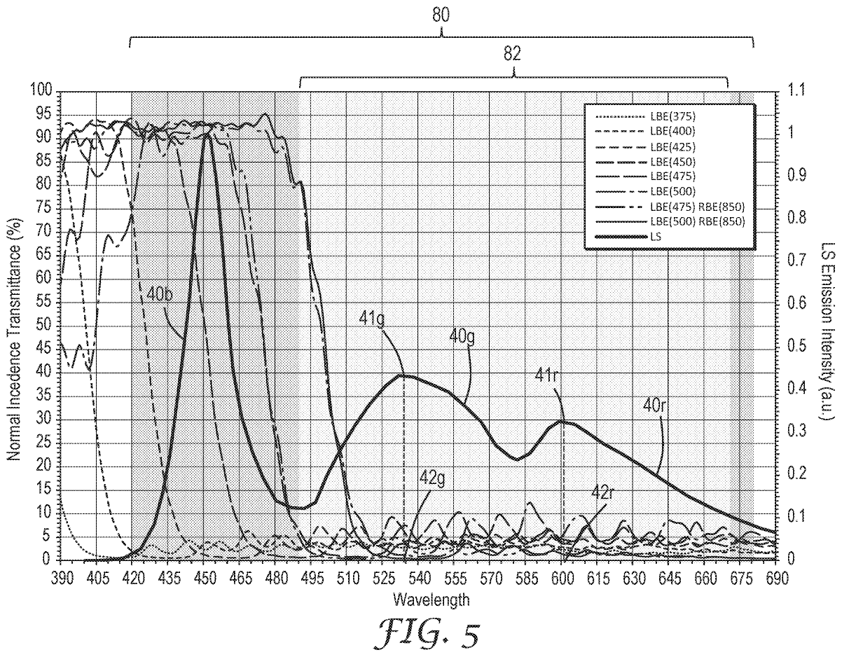

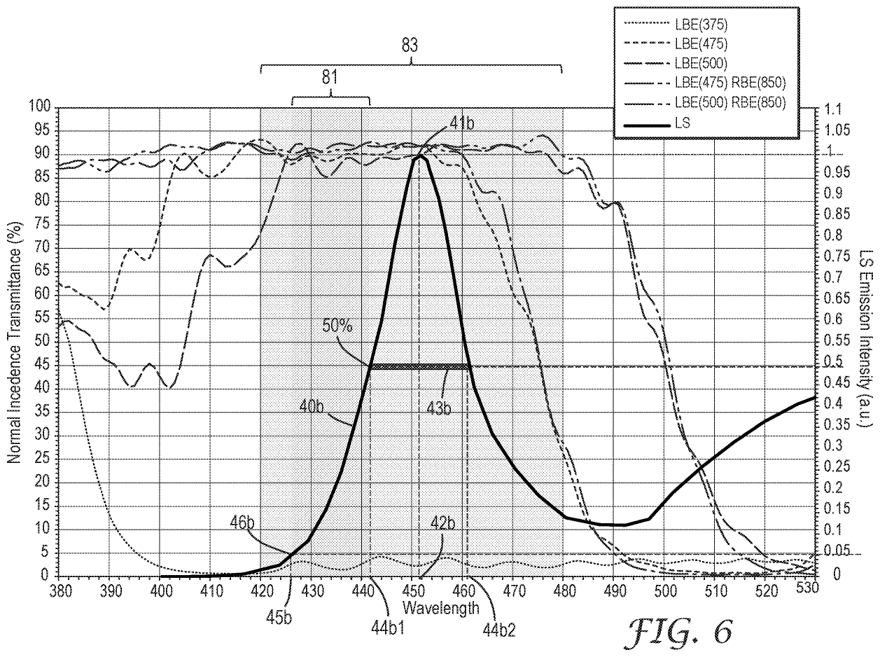

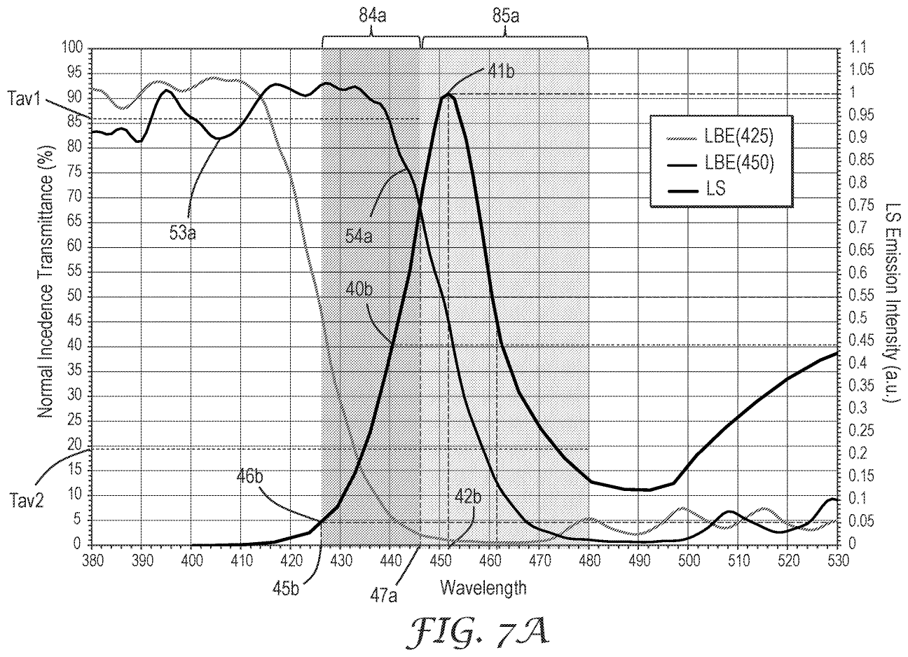

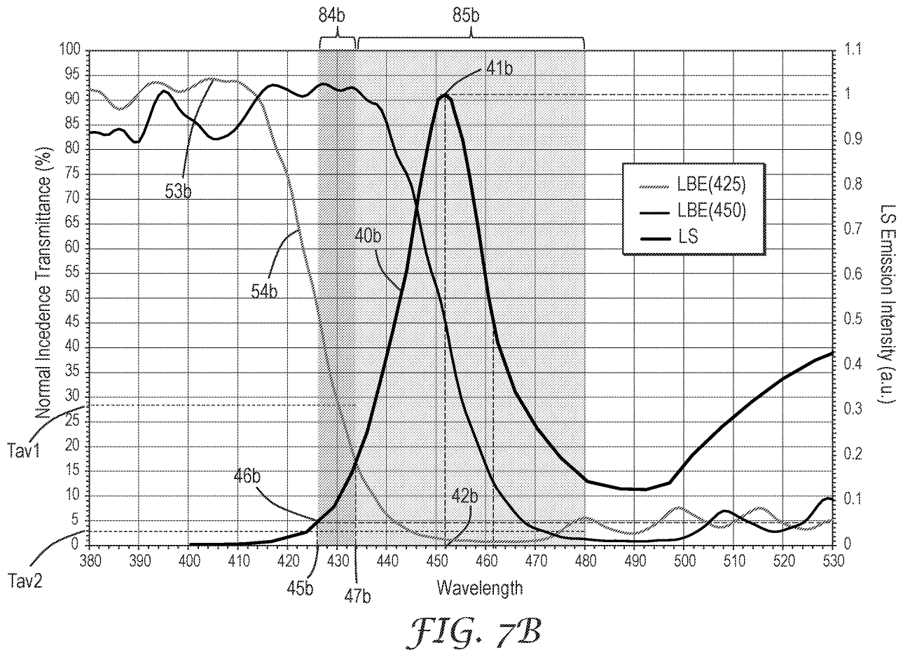

FIG. 5 is a plot of normal incidence transmittance for various illustrative reflective polarizers and a light source (LS) emission intensity (normalized to a largest intensity of unity) versus wavelength, according to some embodiments. The normal incidence transmittance curves in FIG. 5 were calculated using standard optical modeling techniques for alternating PEN and polycarbonate/copolyester blend layers having layer thickness profiles chosen to provide desired reflection band edges. The normal incidence transmittances of the reflective polarizers for the second (block) polarization state can be characterized in terms of their left band edge (LBE) in nm (e.g., LBE (425) refers to a left band edge at 425 nm) and, in some cases, also in terms of their right band edge (RBE) in nm (e.g., LBE (475) RBE (850) refers to a left band edge at 475 nm and a right band edge at 850 nm). The layer thickness profile of FIG. 3 produced the normal incidence transmittance curve labeled LBE (375). In some embodiments, the reflective polarizer 50 has an LBE where a transmittance of the reflective polarizer for substantially normally incident light and for the second polarization state generally decreases with increasing wavelength such that a wavelength along the LBE where the transmittance is at about 55% is in a range of about 420 nm to about 490 nm, or about 425 nm to about 480 nm, for example. FIG. 6 is a plot of normal incidence transmittance for five of the illustrative reflective polarizers and the light source emission intensity of FIG. 5 versus wavelength, according to some embodiments. FIGS. 7A-7B are plots of normal incidence transmittance for two of the illustrative reflective polarizers and the light source emission intensity of FIG. 5 versus wavelength, according to some embodiments.

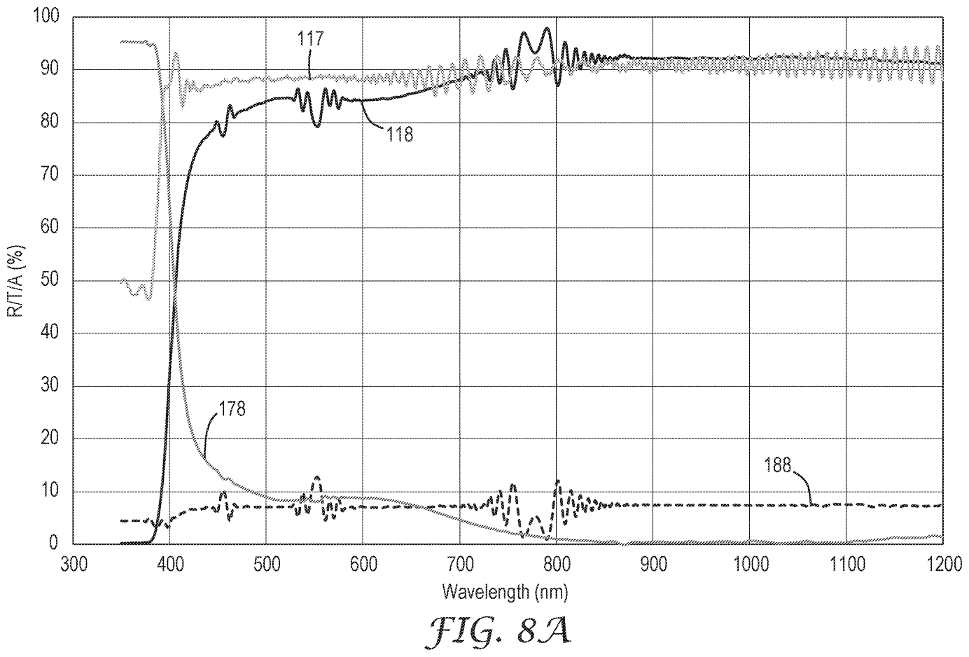

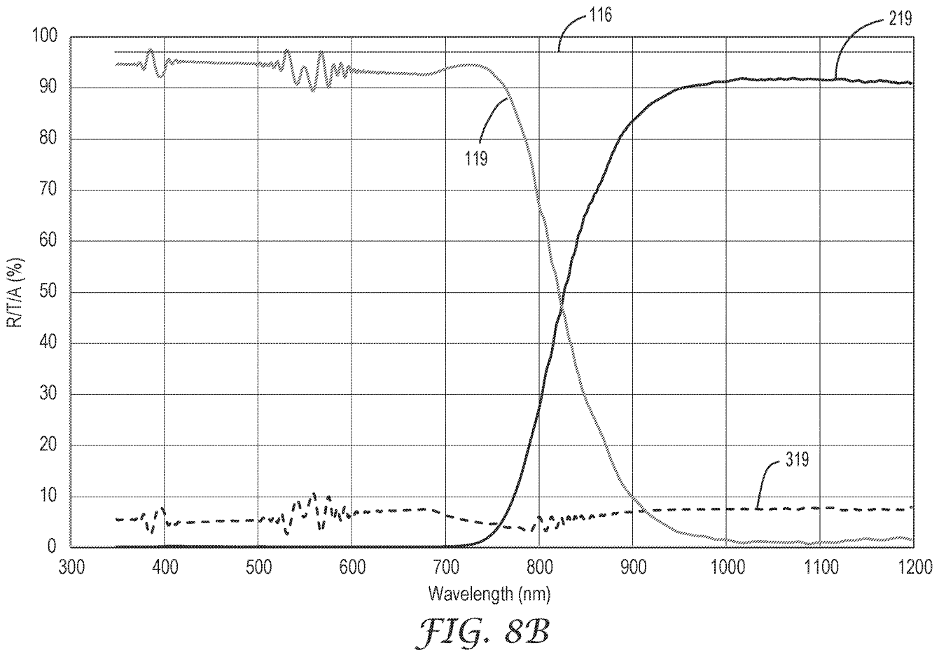

FIGS. 8A-8B are schematic plots of the normal incidence transmittance (T), absorption (A), or reflectance (R) for various optical elements for various polarization states, according to some embodiments. FIG. 8A is a schematic plot of the normal incidence optical transmittance 117 of a reflective polarizer 50 for the first polarization state 171, and the normal incidence optical transmittance 118, optical absorption 178 and optical reflectance 188 of an absorbing polarizer 60 for the first polarization state 171. FIG. 8B is a schematic plot of the normal incidence optical transmittance 219, optical absorption 119 and optical reflectance 319 of the absorbing polarizer 60 for the second polarization state 172, and the normal incidence optical reflectance 116 of a back reflector 90 or regions 92a of a common substrate 92 (see, e.g., FIG. 1) for at least the second polarization state 172. The optical reflectance 116 may be substantially the same for both the first and second polarization states 171 and 172.

The light source of FIGS. 5-6 and 7A-7B has blue (40b), green (40g) and red (40r) emission spectra having respective blue (41b), green (41g) and red (41r) peaks (local intensity maxima) at corresponding respective blue (42b), green (42g) and red (42r) peak wavelengths. The blue emission spectrum 40b has a blue maximum 41b at a blue maximum wavelength 42b and a corresponding blue full width at half the blue maximum (FWHM) 43b extending from a smaller first blue wavelength 44b1 (e.g., about 442 nm in the illustrated embodiment) to a longer second blue wavelength 44b2 (e.g., about 461 nm in the illustrated embodiment).

Table I shows average normal incident transmittance (in percent) for the second polarization state (block state) for various wavelength ranges (in nm) for the reflective polarizers of FIGS. 5-6.

TABLE I

| Wavelength | | | | | | | LBE(475) | LBE(500) |
|---|---|---|---|---|---|---|---|---|
| Range (nm) | LBE(375) | LBE(400) | LBE(425) | LBE(450) | LBE(475) | LBE(500) | RBE(850) | RBE(850) |
| 420-480 | 2.6 | 2.4 | 12.8 | 49.0 | 80.7 | 90.1 | 83.1 | 92.8 |
| 490-670 | 2.6 | 3.1 | 4.1 | 4.5 | 4.7 | 10.2 | 1.5 | 7.0 |
| 427-442 | 2.5 | 0.6 | 18.3 | 89.4 | 90.6 | 89.6 | 92.4 | 92.3 |
| 442-461 | 3.3 | 2.4 | 1.5 | 45.9 | 91.0 | 91.4 | 92.6 | 93.2 |

In some embodiments, for a substantially normally incident light 70, 71, a blue wavelength range 83 (see, e.g., FIG. 6) extending from about 420 nm to about 480 nm, and a green-red wavelength range 82 (see, e.g., FIG. 5) extending from about 490 nm to about 670 nm: for an in-plane first polarization state (e.g., polarized along x-axis), each of the reflective polarizer 50 and the absorbing polarizer 60 has an average optical transmission of greater than about 60%, or 65%, or 70%, or 75%, or 80%, or 85%, or 90% for each of the blue and the green-red wavelength ranges; and for an in-plane orthogonal second polarization state (e.g., polarized along y-axis), the reflective polarizer has an average optical transmission of between about 40% and about 95% in the blue wavelength range 83 and an average optical transmission of less than about 30% in the green-red wavelength range 82, and the absorbing polarizer has an average optical absorption of greater than about 60% in each of the blue and green-red wavelength ranges. In some embodiments, for the second polarization state, the reflective polarizer has an average optical transmission of between about 50%, or 60%, or 70%, or 75%, or 80%, or 85%, or 90% and about 95%, or 90%, or 85%, or 80%, or 75%, or 70%, or 65%, or 60% in the blue wavelength range 83. In some such embodiments, or in other embodiments, for the second polarization state, the reflective polarizer has and an average optical transmission of less than about 25%, or 20%, or 15%, or 10%, or 9%, or 8%, or 7%, or 6%, or 6%, or 4%, or 3%, or 2% in the green-red wavelength range 82. In some such embodiments, or in other embodiments, for the second polarization state, the absorbing polarizer has an average optical absorption of greater than about 65%, or 70%, or 75%, or 80%, or 85%, or 90% in each of the blue and green-red wavelength ranges.

In some embodiments, an optical system 300 includes an extended illumination source 10 configured to emit light (20b, 20g, 20r) from an extended emission surface 11 thereof toward a display panel 30 for forming an image 31, where the emitted light includes a blue emission spectrum 40b having a blue maximum 41b at a blue maximum wavelength 42b and a corresponding blue full width at half the blue maximum (FWHM) 43b extending from a smaller first blue wavelength 44b1 to a longer second blue wavelength 44b2 (see, e.g., FIG. 6). In the embodiment of FIG. 6, the first blue wavelength 44b1 is about 442 nm and the second blue wavelength 44b2 is about 461 nm. More generally, in some embodiments, the first blue wavelength 44b1 can be in a range of about 430 nm to about 450 nm and the second blue wavelength 44b2 can be in a range of about 450 nm to about 470 nm. The FWHM 43b can be at least about 5 or 10 nm, for example. The optical system 300 can include a reflective polarizer 50 disposed on the emission surface 11 of the extended illumination source 10 and including a plurality of polymeric layers 51, 52 numbering at least 10 (or in a range described elsewhere herein) in total where each of the polymeric layers have an average thickness of less than about 500 nm (or in a range described elsewhere herein). The optical system 300 can include an absorbing polarizer 60 disposed on the reflective polarizer 50 opposite the extended emission surface 11.

It can be useful to characterize the reflective polarizer 50 and/or the absorbing polarizer 60 at a blue wavelength 45b which is at a five-percentage 46b of the blue maximum 41b. That is, the blue emission spectrum 40b has an intensity of 5% of the blue maximum 41b at the blue wavelength 45b. In the illustrated embodiments, the blue wavelength 45b is about 427 nm. More generally, in some embodiments, the blue wavelength 45b can be in a range of about 400 nm to about 450 nm, or about 415 nm to about 440 nm, for example. In some embodiments, the optical system 300 is such that for a substantially normally incident light 70, 71 (see, e.g., FIGS. 2 and 4), a visible wavelength range 80 extending from about 420 nm to about 680 nm, a first partial blue wavelength range 81 extending in increasing wavelengths from a third blue wavelength 45b at a five-percentage 46b of the blue maximum 41b to the first blue wavelength 44b1, and a green-red wavelength range 82 extending from about 490 nm to about 670 nm (see, e.g., FIGS. 5-6): for a first polarization state 171, each of the reflective polarizer 50 and the absorbing polarizer 60 has an average optical transmission of greater than about 60%, or 65%, or 70%, or 75%, or 80%, or 85%, or 90% in the visible wavelength range, and an optical transmission of greater than about 50% for each wavelength in the first partial blue wavelength range; and for an orthogonal second polarization state 172, the reflective polarizer has an average optical transmission of greater than about 40% in the first partial blue wavelength range 81 and an average optical transmission of less than about 30% in the green-red wavelength range 82, and the absorbing polarizer has an average optical absorption of greater than about 60% in the visible wavelength range, and an optical absorption of greater than about 50% for each wavelength in the first partial blue wavelength range 81. In some embodiments, for the first polarization state 171, each of the reflective polarizer 50 and the absorbing polarizer 60 has an optical transmission of greater than about 55%, or 60%, or 65%, or 70%, or 75%, or 80%, or 85%, or 90% for each wavelength in the first partial blue wavelength range. In some such embodiments, or in other embodiments, for the second polarization state 172, the reflective polarizer 50 has an average optical transmission of greater than about 50%, or 60%, or 70%, or 75%, or 80%, or 85%, or 90% in the first partial blue wavelength range 81. In some such embodiments, or in other embodiments, for the second polarization state 172, the reflective polarizer 50 has an average optical transmission of less than about 30%, or 25%, or 20%, or 15%, or 10%, or 9%, or 8%, or 7%, or 6%, or 6%, or 4%, or 3%, or 2% in the green-red wavelength range 82. In some such embodiments, or in other embodiments, for the second polarization state 172, the absorbing polarizer has an average optical absorption of greater than about 65%, or 70%, or 75%, or 80%, or 85%, or 90% in the visible wavelength range. In some such embodiments, or in other embodiments, for the second polarization state 172, the absorbing polarizer has an optical absorption of greater than about 50%, or 55%, or 60%, or 65%, or 70%, or 75%, or 80%, or 85%, or 90% for each wavelength in the first partial blue wavelength range 81. A high optical absorption for each wavelength in the first partial blue wavelength range 81 may be desired so that the absorbing polarizer absorbs light having the second polarization state 172 that is transmitted through the reflective polarizer 50 (see, e.g., FIG. 1).

In some embodiments, an optical system 300 includes an illumination source 10 configured to emit light (20b, 20g, 20r) for illuminating a display panel 30 to form an image 31 where the emitted light includes a blue emission spectrum 40b having a blue maximum 41b at a blue maximum wavelength 42b and a lower blue wavelength 45b at a five-percentage 46b of the blue maximum 41b and smaller than the blue maximum wavelength 42b (see, e.g., FIG. 6). In some embodiments, the optical system includes a reflective polarizer 50 disposed on the illumination source 10; and an absorbing polarizer 60 disposed on the reflective polarizer 50 opposite the illumination source 10. In some embodiments, the optical system 300 and/or the optical construction 200 is such that for a substantially normally incident light 70, 71: for a first polarization state 171, each of the reflective polarizer 50 and the absorbing polarizer 60 has an average optical transmission of greater than about 60%, or 65%, or 70%, or 75%, or 80%, or 85%, or 90% for each wavelength in a visible wavelength range 80 extending from about 420 nm to about 680 nm; and for an orthogonal second polarization state 172, an optical transmittance 53a, 53b of the reflective polarizer versus wavelength comprises a left band edge 54a, 54b along which, with increasing wavelengths, the optical transmittance of the reflective polarizer 50 decreases from about 90% to about 10% (see, e.g., FIGS. 7A-7B). In some embodiments, the left band edge 54a, 54b intersects the blue emission spectrum 40b at a higher blue wavelength 47a, 47b disposed between the lower blue wavelength 45b and the blue maximum wavelength 42b. In some embodiments, in a first partial blue wavelength range 84a, 84b from the lower blue wavelength 45b to the higher blue wavelength 47a, 47b and a second partial blue wavelength range 85a, 85b from the higher blue wavelength 47a, 47b to about 480 nm, the reflective polarizer 50 has respective average optical transmittances Tav1 and Tav2, where Tav1/Tav2≥2, or 3, or 4, or 5, or 6, or 7, or 8, or 9. In some such embodiments, or in other embodiments, the absorbing polarizer 60 has an average optical absorption of greater than about 50%, or 55%, or 60%, or 65%, or 70%, or 75%, or 80%, or 85%, or 90% in each of the first and second partial blue wavelength ranges. As illustrated in FIG. 7A for the reflective polarizer LBE (450), the average optical transmittance Tav1 is about 86.2 percent in the first partial blue wavelength range 84a (about 427 nm to about 446 nm) and about 19.8 percent in the second partial blue wavelength range 85a (about 446 nm to about 480 nm), so that Tav1/Tav2 is about 4.4. As illustrated in FIG. 7B for the reflective polarizer LBE (425), the average optical transmittance Tav1 is about 28.1 percent in the first partial blue wavelength range 84a (about 427 nm to about 434 nm) and about 3.1 percent in the second partial blue wavelength range 85a (about 434 nm to about 480 nm), so that Tav1/Tav2 is about 9.

In some embodiments, for the first polarization state 171, each of the reflective polarizer 50 and the absorbing polarizer 60 has an optical transmission of greater than about 50%, or 55%, or 60%, or 65%, or 70%, or 75%, or 80%, or 85%, or 90% for each wavelength in the first partial blue wavelength range 84a, 84b. In some such embodiments, or in other embodiments, for the first polarization state 171, each of the reflective polarizer 50 and the absorbing polarizer 60 has an optical transmission of greater than about 50%, or 55%, or 60%, or 65%, or 70%, or 75%, or 80%, or 85%, or 90% for each wavelength in the visible wavelength range 80 (see, e.g., FIG. 5). In some such embodiments, or in other embodiments, for the second polarization state 172, the reflective polarizer 50 has an average optical transmission of greater than about 40%, or 50%, or 60%, or 70%, or 75%, or 80%, or 85%, or 90% in the first partial blue wavelength range 84a, 84b. In some such embodiments, or in other embodiments, for the second polarization state 172, the reflective polarizer 50 has an average optical transmission of less than about 30%, or 25%, or 20%, or 15%, or 10%, or 9%, or 8%, or 7%, or 6%, or 6%, or 4%, or 3%, or 2% in a green-red wavelength range 82 extending from about 490 nm to about 670 nm (see, e.g., FIG. 5). In some such embodiments, or in other embodiments, for the second polarization state 172, the absorbing polarizer 60 has an average optical absorption of greater than about 60%, or 65%, or 70%, or 75%, or 80%, or 85%, or 90% in the visible wavelength range 80. In some such embodiments, or in other embodiments, for the second polarization state 172, the absorbing polarizer 60 has an optical absorption of greater than about 50% or 55%, or 60%, or 65%, or 70%, or 75%, or 80%, or 85%, or 90% for each wavelength in the first partial blue wavelength range 84a, 84b.

Returning to FIG. 1, in some embodiments, the extended illumination source 10 includes a plurality of discrete spaced apart blue-light-emitting light sources 91b configured to emit blue light 20b comprising the blue emission spectrum. In some embodiments, the discrete spaced apart blue-light-emitting light sources 91b are mounted on a common substrate 92. In some embodiments, regions 92a of the common substrate 92 between the light sources 91b have an optical reflectance of greater than about 50%, or 55%, or 60%, or 65%, or 70%, or 75%, or 80%, or 85%, or 90%, or 95% in the visible wavelength range 80 for at least the second polarization state (block state). In some embodiments, the extended illumination source 10 further includes one or more light converting films 100g, 100r disposed on the blue-light-emitting light sources 91b and configured to receive the emitted blue-light and convert at least portions of the received emitted blue-light to green (20g) and red (20r) lights exiting the extended illumination source through the emission surface 11 and, as described further elsewhere herein, having respective green (40g) and red (40r) emission spectra including, in the visible wavelength range, respective green (41g) and red (41r) peaks at corresponding respective green (42g) and red (42r) peak wavelengths (see, e.g., FIG. 5), such that for each of the green and red peak wavelengths: for the first polarization state (pass state), each of the reflective polarizer 50 and the absorbing polarizer 60 has an optical transmission of greater than about 60%; and for the second polarization state (block state), the reflective polarizer 50 has an optical reflectance of greater than about 60% and the absorbing polarizer has an average optical absorption of greater than about 60%. The light converting films 100g and 100r may be configured to convert at least portions of blue light to primarily green and red lights, respectively. In some embodiments, a single light converting film is used to covert at least portions of blue light to green and red lights. In some embodiments, for each of the green and red peak wavelengths and for the first polarization state, each of the reflective polarizer 50 and the absorbing polarizer 60 has an optical transmission of greater than about 65%, or 70%, or 75%, or 80%, or 85%, or 90%. In some such embodiments, or in other embodiments, for each of the green and red peak wavelengths and for the second polarization state, the reflective polarizer 50 has an optical reflectance of greater than about 60%, or 65%, or 70%, or 75%, or 80%, or 85%, or 90%. In some such embodiments, or in other embodiments, for each of the green and red peak wavelengths and for the second polarization state, the absorbing polarizer 60 has an average optical absorption of greater than about 60%, or 65%, or 70%, or 75%, or 80%, or 85%, or 90%.

In some embodiments, the extended illumination source 10 includes a plurality of discrete spaced apart blue-light-emitting light sources 93b, a plurality of discrete spaced apart green-light-emitting light sources 93g, and a plurality of discrete spaced apart red-light-emitting light sources 93r. The blue-, green- and red-light emitting light sources (e.g., LEDs) can emit primarily in blue, green, and red wavelength ranges of about 420 nm to about 480 nm, about 490 nm to about 580 nm, and about 585 nm to about 680 nm, respectively. The blue-, green-, and red-light emitting sources include respectively, the blue emission spectrum 40b, a green emission spectrum 40g and a red emission spectrum 40r, where the green and red emission spectra include, in the visible wavelength range, respective green (41g) and red (41r) peaks at corresponding respective green (42g) and red (42r) peak wavelengths (see, e.g., FIG. 6), such that for each of the green and red peak wavelengths: for the first polarization state (pass state), each of the reflective polarizer and the absorbing polarizer has an optical transmission of greater than about 60%, or 65%, or 70%, or 75%, or 80%, or 85%, or 90%; and for the second polarization state (block state), the reflective polarizer has an optical reflectance of greater than about 60% and the absorbing polarizer has an optical absorption of greater than about 60%. In some embodiments, for each of the green and red peak wavelengths and for the second polarization state, the reflective polarizer 50 has an optical reflectance of greater than about 65%, or 70%, or 75%, or 80%, or 85%, or 90%. In some such embodiments, or in other embodiments, for each of the green and red peak wavelengths and for the second polarization state, the absorbing polarizer has an optical absorption of greater than about 65%, or 70%, or 75%, or 80%, or 85%, or 90%.

In some embodiments, the pluralities of discrete spaced apart blue-, green-, and red-light-emitting light sources are mounted on a common substrate 94, and regions 94a of the common substrate 94 between the light sources have an optical reflectance of greater than about 50%, or 55%, or 60%, or 65%, or 70%, or 75%, or 80%, or 85%, or 90%, or 95% in the visible wavelength range for at least the second polarization state (e.g., for the second polarization state and optionally also for the first polarization state).

In some embodiments, the extended illumination source 10 includes at least one lightguide (99a, 99b); a light source (95a, 95b) disposed proximate a minor surface 96a, 96b of the at least one lightguide and configured to emit light 97a, 97b; and a back reflector 90 disposed proximate the at least one lightguide and configured to recycle at least some of the light emitted by the light source and reflected (21b, 21g, 21r) toward the extended illumination source 10 by at least the reflective polarizer 50. The back reflector 90 can have an average optical reflectance of at least 60% (or in a range described elsewhere herein) in the visible wavelength range for at least the second polarization state 172.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1. An optical system comprising:
an extended illumination source configured to emit light from an extended emission surface thereof toward a display panel for forming an image, the emitted light comprising a blue emission spectrum having a blue maximum at a blue maximum wavelength and a corresponding blue full width at half the blue maximum (FWHM) extending from a smaller first blue wavelength to a longer second blue wavelength;
a reflective polarizer disposed on the emission surface of the extended illumination source and comprising a plurality of polymeric layers numbering at least 10 in total, each of the polymeric layers having an average thickness of less than about 500 nm; and
an absorbing polarizer disposed on the reflective polarizer opposite the extended emission surface,
such that for a substantially normally incident light, a visible wavelength range extending from about 420 nm to about 680 nm, a first partial blue wavelength range extending in increasing wavelengths from a third blue wavelength at a five-percentage of the blue maximum to the first blue wavelength, and a green-red wavelength range extending from about 490 nm to about 670 nm:
for a first polarization state, each of the reflective polarizer and the absorbing polarizer has an average optical transmission of greater than about 60% in the visible wavelength range, and an optical transmission of greater than about 50% for each wavelength in the first partial blue wavelength range; and
for an orthogonal second polarization state, the reflective polarizer has an average optical transmission of greater than about 40% in the first partial blue wavelength range and an average optical transmission of less than about 30% in the green-red wavelength range, and the absorbing polarizer has an average optical absorption of greater than about 60% in the visible wavelength range, and an optical absorption of greater than about 50% for each wavelength in the first partial blue wavelength range.

2. The optical system of claim 1 further comprising a display panel disposed on the absorbing polarizer opposite the reflective polarizer and configured to receive the emitted light from the extended illumination source and form an image.

3. The optical system of claim 1, wherein the extended illumination source comprises a back reflector configured to recycle at least some of the emitted light reflected toward the extended illumination source by at least the reflective polarizer, the back reflector having an average optical reflectance of at least 60% in the visible wavelength range for at least the second polarization state.

4. The optical system of claim 1, wherein the extended illumination source comprises a plurality of discrete spaced apart blue-light-emitting light sources configured to emit blue light comprising the blue emission spectrum.

5. The optical system of claim 4, wherein the discrete spaced apart blue-light-emitting light sources are mounted on a common substrate, and wherein regions of the common substrate between the light sources have an optical reflectance of greater than about 50% in the visible wavelength range for at least the second polarization state.

6. The optical system of claim 4, wherein the extended illumination source further comprises one or more light converting films disposed on the blue-light-emitting light sources and configured to receive the emitted blue-light and convert at least portions of the received emitted blue-light to green and red lights exiting the extended illumination source through the emission surface and having respective green and red emission spectra comprising, in the visible wavelength range, respective green and red peaks at corresponding respective green and red peak wavelengths, such that for each of the green and red peak wavelengths:
for the first polarization state, each of the reflective polarizer and the absorbing polarizer has an optical transmission of greater than about 60%; and
for the second polarization state, the reflective polarizer has an optical reflectance of greater than about 60% and the absorbing polarizer has an average optical absorption of greater than about 60%.

7. The optical system of claim 1, wherein the extended illumination source comprises a plurality of discrete spaced apart blue-light-emitting light sources, a plurality of discrete spaced apart green-light-emitting light sources, and a plurality of discrete spaced apart red-light-emitting light sources, the blue-, green-, and red-light emitting sources comprising respectively, the blue emission spectrum, a green emission spectrum and a red emission spectrum, the green and red emission spectra comprising, in the visible wavelength range, respective green and red peaks at corresponding respective green and red peak wavelengths, such that for each of the green and red peak wavelengths:
for the first polarization state, each of the reflective polarizer and the absorbing polarizer has an optical transmission of greater than about 60%; and
for the second polarization state, the reflective polarizer has an optical reflectance of greater than about 60% and the absorbing polarizer has an optical absorption of greater than about 60%.

8. The optical system of claim 1, wherein the extended illumination source comprises:
at least one lightguide;
a light source disposed proximate a minor surface of the at least one lightguide and configured to emit light; and
a back reflector disposed proximate the at least one lightguide and configured to recycle at least some of the light emitted by the light source and reflected toward the extended illumination source by at least the reflective polarizer, the back reflector having an average optical reflectance of at least 60% in the visible wavelength range for at least the second polarization state.

9. An optical system comprising an extended illumination source configured to emit light from an extended emission surface thereof; and an optical construction disposed on the extended illumination source, the optical construction comprising:
a reflective polarizer comprising a plurality of polymeric layers numbering at least 100 in total, each of the polymeric layers having an average thickness of less than about 500 nm; and
an absorbing polarizer disposed on, and substantially coextensive in length and width with, the reflective polarizer, the reflective polarizer disposed between the absorbing polarizer and the extended illumination source,
such that for a substantially normally incident light, a blue wavelength range extending from about 420 nm to about 480 nm, and a green-red wavelength range extending from about 490 nm to about 670 nm:
for an in-plane first polarization state, each of the reflective polarizer and the absorbing polarizer has an average optical transmission of greater than about 60% for each of the blue and the green-red wavelength ranges; and
for an in-plane orthogonal second polarization state, the reflective polarizer has an average optical transmission of between about 40% and about 95% in the blue wavelength range and an average optical transmission of less than about 30% in the green-red wavelength range, and the absorbing polarizer has an average optical absorption of greater than about 60% in each of the blue and green-red wavelength ranges.

10. The optical system of claim 9, wherein the plurality of polymeric layers in the reflective polarizer comprises a plurality of alternating different polymeric first and second layers numbering at least 150 in total, each of the polymeric first and second layers having an average thickness of less than about 400 nm.

11. The optical system of claim 10, wherein the polymeric first layers comprise polyethylene naphthalate (PEN) and the polymeric second layers comprise at least one of a polycarbonate or a copolyester.

12. (canceled)

13. The optical system of claim 9, wherein the light emitted from the extended emission surface comprises a blue emission spectrum having a blue maximum at a blue maximum wavelength and a lower blue wavelength at a five-percentage of the blue maximum and smaller than the blue maximum wavelength, such that for the substantially normally incident light and for the second polarization state, an optical transmittance of the reflective polarizer versus wavelength comprises a left band edge along which, with increasing wavelengths, the optical transmittance of the reflective polarizer decreases from about 90% to about 10%, the left band edge intersecting the blue emission spectrum at a higher blue wavelength disposed between the lower blue wavelength and the blue maximum wavelength, wherein in a first partial blue wavelength range from the lower blue wavelength to the higher blue wavelength and a second partial blue wavelength range from the higher blue wavelength to about 480 nm, the reflective polarizer has respective average optical transmittances Tav1 and Tav2, Tav1/Tav2≥2.

14. An optical system comprising:
an illumination source configured to emit light for illuminating a display panel to form an image, the emitted light comprising a blue emission spectrum having a blue maximum at a blue maximum wavelength and a lower blue wavelength at a five-percentage of the blue maximum and smaller than the blue maximum wavelength;
a reflective polarizer disposed on the illumination source; and
an absorbing polarizer disposed on the reflective polarizer opposite the illumination source, such that for a substantially normally incident light:
for a first polarization state, each of the reflective polarizer and the absorbing polarizer has an average optical transmission of greater than about 60% a visible wavelength range extending from about 420 nm to about 680 nm; and
for an orthogonal second polarization state, an optical transmittance of the reflective polarizer versus wavelength comprises a left band edge along which, with increasing wavelengths, the optical transmittance of the reflective polarizer decreases from about 90% to about 10%, the left band edge intersecting the blue emission spectrum at a higher blue wavelength disposed between the lower blue wavelength and the blue maximum wavelength, wherein in a first partial blue wavelength range from the lower blue wavelength to the higher blue wavelength and a second partial blue wavelength range from the higher blue wavelength to about 480 nm, the reflective polarizer has respective average optical transmittances Tav1 and Tav2, Tav1/Tav2≥2, and the absorbing polarizer has an average optical absorption of greater than about 50% in each of the first and second partial blue wavelength ranges.

15. The optical system of claim 14, wherein for the second polarization state, the absorbing polarizer has an optical absorption of greater than about 60% for each wavelength in the first partial blue wavelength range.

16. The optical system of claim 13, wherein for the substantially normally incident light and for the second polarization state, the absorbing polarizer has an average optical absorption of greater than about 55% in each of the first and second partial blue wavelength ranges.
